(19) United States
(12) Patent Application Publication
(10) Pub. No.: US 2023/0080172 A1
(43) Pub. Date: Mar. 16, 2023

(54) TRANSMITTING NODE INSTRUCTIONS

(71) Applicant: Hewlett-Packard Development Company, L.P., Spring, TX (US)

(72) Inventor: John W. Lance, Spring, TX (US)

(73) Assignee: Hewlett-Packard Development Company, L.P., Spring, TX (US)

(21) Appl. No.: 17/799,697

(22) PCT Filed: Mar. 13, 2020
(86) PCT No.: PCT/US2020/022570

§ 371 Date: Aug. 15, 2022

(51) Int. Cl. G06N 3/063

(52) U.S. Cl. CPC G06N 3/063

(57) ABSTRACT

In some examples, transmitting node instructions can include a logical node of a neural network to: receive a first node instruction, generate an output change value based on the received first node instruction, and transmit the output change value and the first node instruction to a logical edge, and the logical edge of the neural network to: receive the output change value and the first node instruction from the logical node, generate a second node instruction based on the output change value and the first node instruction, and transmit the second node instruction.

### BACKGROUND

Computing devices can be utilized to process a knowledge base based on particular inputs. In some examples, the computing devices can utilize a relatively large quantity of computing resources (e.g., processing resources, memory resources, electrical resources, etc.) to generate acceptable outputs for the knowledge base for a corresponding input. In some examples, the inputs can change on a relatively consistent basis (e.g., daily, etc.) and the computing devices may have to reevaluate the knowledge base whenever a particular input changes.

### BRIEF DESCRIPTION OF THE DRAWINGS

FIG. 1 illustrates a system for transmitting node instructions consistent with the disclosure.

FIG. 2 illustrates a device for transmitting node instructions consistent with the disclosure.

FIG. 3 illustrates a machine readable medium storing instructions for transmitting node instructions consistent with the disclosure.

FIG. 4 illustrates a system for transmitting node instructions consistent with the disclosure.

FIG. 5 illustrates a system for transmitting node instructions consistent with the disclosure.

FIG. 6 illustrates a flow diagram for transmitting node instructions consistent with the disclosure.

FIG. 7 illustrates a logical edge for transmitting node instructions consistent with the disclosure.

### DETAILED DESCRIPTION

Knowledge bases (KBs) can include information relating to a plurality of elements. For example, knowledge bases can be databases of information that can include descriptions of physical devices associated with a particular entity (e.g., business, corporation, company, etc.). In this example, the physical devices can each include a plurality of configurations. In some examples, the device configurations can include a particular compilation of parts with particular properties. For example, the physical devices can be computing devices. In this example, the knowledge base can include a configuration that includes options of: a computing device type (e.g., laptop, desktop, tablet, smart phone, etc.), computing device instructions (e.g., software, firmware, etc.), computing device operating system, computing device processor, computing device memory, computing device color, among other parts of a computing device that can be selected for a particular computing device configuration.

In some examples, the knowledge base can utilize inputs to determine a plurality of outputs that are acceptable based on provided inputs. For example, the inputs can include features or parts of a computing device. In this example, the features or parts can include, but are not limited to memory type, processor type, and/or hard drive type. In this example, the input can be a value or selection related to selected features or parts. In some examples, the list of outputs can be based on the selected features. In some examples, the outputs for a selection may have to be recalculated for the entire knowledge base. This can be resource intensive since the entire knowledge base may have to be utilized to determine what outputs are acceptable for the selected inputs. That is, even though there are portions of the knowledge base that are not affected by the input, the input would still have to be utilized with these portions of the knowledge base in order to generate the list of outputs. In this way, an update or alteration of the inputs can cause a delay in retrieving the list of outputs since portions of the knowledge base that are not altered will still be utilized to determine the list of outputs.

As such, the disclosure is directed to transmitting node instructions. In some examples, transmitting node instructions can include utilizing a neural network that includes a plurality of logical nodes that can update outputs of a knowledge base by utilizing portions of a knowledge base that are affected by a change (e.g., condition, price, input, etc.) and not utilizing portions of the knowledge base that are not affected by the change. In this way, computing resources can be conserved, and an updated output of the knowledge base can be generated in relatively less time compared to previous systems. For example, transmitting node instructions can include a device comprising a first logical node of a neural network to receive a first node instruction, generate an output change value based on the received first node instruction, and transmit the output change value and the first node instruction to a logical edge. The device can also include the logical edge of the neural network to receive the output change value and the first node instruction from the first logical node, generate a second node instruction based on the output change value and the first node instruction, and transmit the second node instruction.

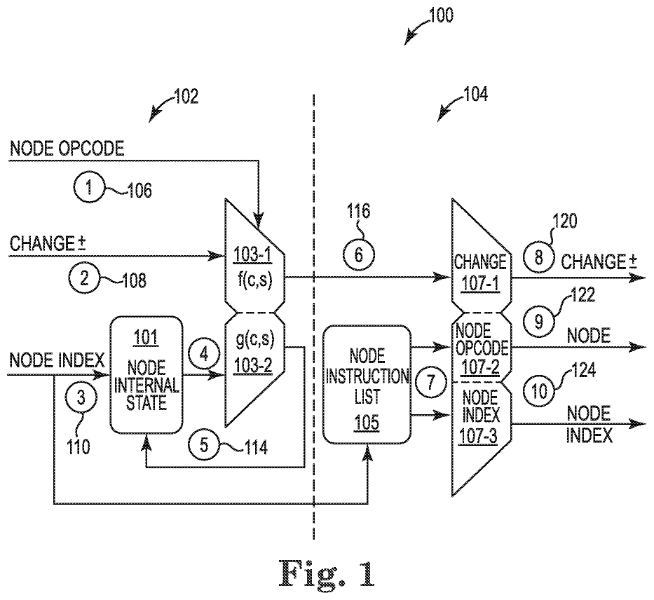

FIG. 1 illustrates a neural network 100 for transmitting node instructions consistent with the disclosure. In some examples, the neural network 100 can include a logical node 102 communicatively coupled to a logical edge 104. In some examples, the logical node 102 and the logical edge 104 can be logical devices of a neural network within a computing device. As used herein, a logical node, logical edge, and/or logical device can include a logical partition of memory resources and/or processing resources. For example, the logical node 102 can be a logical node device that can include a memory resource to store instructions that can be executed by a processing resource and the logical edge 104 can be a logical edge device that can include a logically separated memory resource to store instructions that can be executed by the processing resource. In some examples, the processing resource can be a virtual processing resource that can execute instructions stored on a plurality of logical nodes, logical edges, and/or logical devices within the neural network 100.

In some examples, the neural network 100 can be part of a computing device. In these examples, the neural network 100 can be part of a computing device that can include a processing resource and/or a memory resource that can be logically separated into a plurality of logical devices (e.g., logical node 102, logical edge 104, etc.) storing instructions to perform particular functions. A processing resource, as used herein, can include a number of processing resources capable of executing instructions stored by a memory resource. The instructions (e.g., machine-readable instructions (MRI), computer-readable instructions (CRI), etc.) can include instructions stored on the memory resource and executable by the processing resource to perform or implement a particular function. The memory resource 104, as used herein, can include a number of memory components capable of storing non-transitory instructions that can be executed by the processing resource.

The memory resource can be in communication with the processing resource via a communication link (e.g., communication path). The communication link can be local or remote to an electronic device associated with the processing resource. In some examples, instructions (e.g., software, firmware, etc.) can be downloaded and stored in memory resource (e.g., MRM) as well as a hard-wired program (e.g., logic), among other possibilities. In other examples, the computing device can be hardware, such as an application-specific integrated circuit (ASIC), that can include instructions to perform particular functions.

In some examples, the logical node 102 can include instructions 103-1, 103-2 that can be executed by a processing resource. For example, the instructions 103-1 can be executed in response to a node operation code (opcode) 106 and/or a change value 108. In another example, the instructions 103-2 can be executed in response to a node index 110 (e.g., a node memory map, etc.) being provided to a node internal state 101. As used herein, a node index 110 or node memory map can be a representation of interconnections between a plurality of logical nodes within the neural network 100. For example, the node index 110 can illustrate that the logical node 102 is communicatively coupled to the logical edge 104. In addition, the node index 110 can illustrate that the logical node 102 is coupled to a plurality of other nodes within the neural network 100 and operation codes for the plurality of other nodes within the neural network 100.

In some examples, the instructions 103-2 can generate an updated node internal state to be stored as in the node internal state 101 at 114. In some examples, the instructions 103-1 can include a function (e.g., f(c,s), etc.) that can be utilized to determine a change value 116 based on the node opcode 106 and/or change value 108. For example, the instructions 103-1 can include a function that utilizes a current state value for the logical node 102, an opcode to determine an operation to perform with an input change value 108 and current state value to determine an updated state value and an output change value 116 (e.g., change in the current state). In some examples, the logical node 102 can transfer the change value 116 to the logical edge 104 to be transferred to a plurality of logical nodes and/or the logical node 102 based on the output change value 116. As described herein, the logical node 102 can be communicatively coupled to the logical edge 104 through a communication link.

In some examples, the logical node 102 can determine that the updated change value 116 (e.g., output change value, etc.) generated by the instructions 103-1 is to be transferred to the logical edge 104 based on the node index 110 and the updated change value 116. In some examples, the logical node 102 can determine a plurality of nodes to provide the updated change value 116 and a plurality of nodes to not provide the updated change value 116. For example, the change value 108 (e.g., input change value, etc.) can be utilized by the logical node 102 to determine which of a plurality of other nodes receive the updated change value 116. In this way, nodes that are affected by the change value 108 and/or the updated change value 116 will receive the updated change value 116 and nodes that are not affected by the change value 108 and/or the updated change value 116 are not provided with the updated change value 116 to save on computing resources and/or time it takes to generate an updated knowledge base.

In some examples, the logical edge 104 can include instructions 107-1, 107-2, 107-3. In some examples, the logical edge 104 can be a logical edge device. As used herein, a logical edge device can include an edge of the neural network 100 that can be communicatively coupled to a device or system outside the neural network 100. In some examples, the logical edge 104 can be an edge device positioned between the logical node 102 and a plurality of other logical nodes. In some examples, the instructions 107-1 can receive the updated change value 116 from the logical node 102. In some examples, the updated change value 116 can be utilized by the logical edge 104 to determine a plurality of nodes coupled to the logical edge 104 that are affected by the updated change value 116. In some examples, the logical node 102 can provide a node instruction list 105 to the logical edge 104. In some examples, the node instruction list 105 can include a node index, a node opcode 122, and/or a node internal state 101 of the logical node 102. In some examples, the node opcode 122 can be provided to instructions 107-2 to determine a plurality of logical nodes or devices to provide the updated change value 116 based on an opcode associated within the plurality of logical nodes or devices. For example, the node opcode 122 can refer to an operation that is performed by a particular logical node or device. For example, a node opcode 122 can refer to an addition function, a boolean function, a subtraction function, a multiplication function, among other types of operation codes that are utilized in computing. In this way, the logical edge 104 can determine how a particular node of the plurality of logical nodes are going to be affected by the updated change value 116 from the logical node 102.

In some examples, the instructions 107-3 can receive a node index from the node instruction list 105 to determine a node to transfer the updated change value 116 as updated change value 120, node opcode 122, and/or node index 124. As described herein, the instructions 107-3 can determine that a plurality of nodes and/or external devices are affected by the updated change value 116 and transmit the change value 120, node opcode 122, and/or node index 124 to the plurality of nodes and/or external devices.

In some examples, a knowledge base as described herein, can be converted into a neural network 100. In some examples, each element of the knowledge base can be converted to a corresponding logical node similar to logical node 102 and connected to other logical nodes through logical edges similar to logical edge 104. In this way, a new set of outputs can be generated for particular inputs based on the change value provided to the plurality of nodes and only nodes affected by the change value are provided within instructions to update a corresponding internal state value.

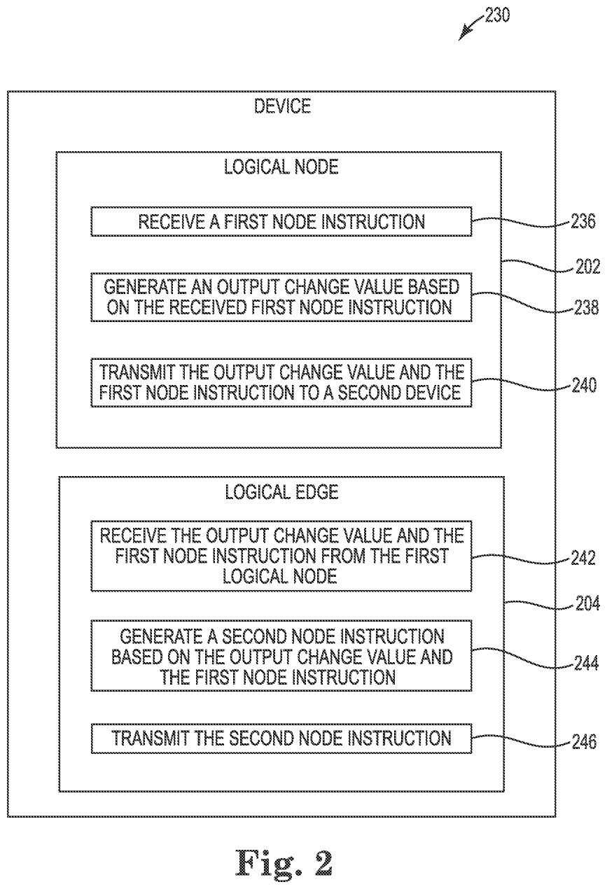

FIG. 2 illustrates a device 230 for transmitting node instructions consistent with the disclosure. The device 230 may include a logical node 202 and a logical edge 204 to transmit node instructions. The logical node 202 can be, for example, the logical node 102 previously described in connection with FIG. 1. The logical edge 204 can be, for example, a logical edge 104 previously described in connection with FIG. 1.

Although not illustrated in FIG. 2, the device 230 may be a computing device that includes a processor and a machine-readable storage medium. Although the following descriptions refer to a single processor and a single machine-readable storage medium, the descriptions may also apply to a system with multiple processors and multiple machine-readable storage mediums. In such examples, the device 230 may be distributed across multiple machine-readable storage mediums and across multiple processors. Put another way, the instructions executed by the device 230 may be stored across multiple machine-readable storage mediums and executed across multiple processors, such as in a distributed or virtual computing environment.

In some examples, the logical node 202 can include a logical partition of memory resources that can be communicatively coupled to a processing resource that can execute instructions 236, 238, 240. In some examples, the logical node 202 can include instructions 236 that when executed by a processing resource can receive a first node instruction. In some examples, the first node instruction can include information that can be utilized by the logical node 202 to generate a change value. For example, the first node instruction can include a node opcode (e.g., operation code, etc.), a change value, a node index, and/or a node internal state. In some examples, the node internal state is stored in memory associated within the logical node 202 and can be updated as change values are received.

In this example, the first node instruction can be utilized by the logical node 202 to generate an updated change value and/or determine a portion of a plurality of logical nodes for providing the updated change value. For example, the logical node 202 can generate an updated change value (e.g., output change value, etc.) and determine that the logical node 202 is to transfer the updated change value to a logical edge 204 based on the first node instruction and/or whether other logical nodes coupled to the logical edge 204 are affected by the updated change value.

In some examples, the logical node 202 can include instructions 238 that when executed by a processing resource can generate an output change value based on the received first node instruction. As described herein, the logical node 202 can generate an output change value based on the received first node instruction. In some examples, the first node instruction can include an input change value that can be utilized to generate the output change value. As used herein, an input change value can be a change value that is received by a logical node. For example, the logical node 202 can receive an input change value from another logical node and/or external system. In this example, the input change value can represent a change in conditions that can affect the internal state of the logical node 202 as described herein. For example, the element of the knowledge base that is represented by logical node 202 can represent a current state based on particular selections. In this example, the change value can represent a change in particular selections that can affect the plurality element represented by logical node 202.

In some examples, the logical node 202 can generate the output change value utilizing instructions stored within the logical node 202. As described herein, the instructions stored within the logical node 202 can be executed as a function that utilizes an input change value and the node instructions received by the first logical node 202. For example, the function can include determining a current state value for the logical node 202, determining the opcode for the logical node 202, and performing the opcode on the state value based on an input change value. In this way, the input change value is operated on the current state value based on the opcode for the logical node 202 to determine the updated state value and output change value. In some examples, the logical node 202 can utilize the output change value to determine a number of different logical nodes that are affected by the output change value. For example, the logical node 202 can utilize a node index (e.g., node map, etc.) for the neural network to identify other logical nodes within the neural network that are affected by the output change value. In this example, the logical node 202 can transmit the output change value and the first node instruction to the identified logical nodes within the neural network that are affected by the output change value utilizing the logical edge 204 as described herein.

In some examples, the logical node 202 can include instructions 240 that when executed by a processing resource can transmit the output change value and the first node instruction to a logical edge 204. As described herein, the logical node 202 can transmit the output change value and the first node instruction to the logical edge 204 to transmit a generated second node instruction to a plurality of other logical nodes and/or external devices based on the output change value and/or an opcode associated with the plurality of other logical nodes and/or external devices. In some examples, the logical edge 204 can receive the output change value from the logical edge 204 and utilize the output change value as an input change value to be transferred to a plurality of other logical nodes and/or external devices. In some examples, logical nodes that are not affected by the output change value and/or the input change value can retain a current node state value that corresponds to a value within the knowledge base and thus resources are not utilized to regenerate the values when the output change value or input change value does not alter or affect the current value within particular nodes of the knowledge base neural network.

In some examples, the logical edge 204 can include instructions 242 that when executed by a processing resource can receive the output change value and the first node instruction from the logical node 202. As described herein, the logical edge 204 can receive the output change value when the logical edge 204 is coupled to other logical nodes and/or devices that are affected by the output change value. In this way, the logical edge 204 can utilize the output change value and the first node instruction as inputs to be provided to other logical nodes and/or devices to generate an additional output change value, update an internal state associated with the other logical nodes and/or devices based on the inputs.

In some examples, the logical edge 204 can include instructions 244 that when executed by a processing resource can generate a second node instruction based on the output change value and the first node instruction. As described herein, the second node instruction can include information that is generated based on the received output change value and first node instruction received from the first logical node 202, In some examples, the second node instruction can include an instruction to be transmitted to a different logical node (e.g., third logical node, edge logical node, etc.). In some examples, the second node instruction can be directed to the different logical node to instruct the different logical node on processing an output change value that can be provided by the logical edge 204.

In some examples, the logical edge 204 can include instructions 246 that when executed by a processing resource can transmit the second node instruction. As described herein, the second logical node 204 can be communicatively coupled to the logical node 202 such that the logical edge 204 can receive information from the logical node 202. In some examples, the logical edge 204 can be communicatively coupled to a plurality of additional logical nodes and/or external devices. In some examples, the logical edge 204 can utilize a node index to determine a number of logical nodes that are affected by an output change value that is generated by the logical node 202. In this way, the logical edge 204 can transmit the second node instruction and/or updated output change value to a number of other logical nodes that are affected by the updated output change value and/or the second node instruction. In this way, a plurality of logical nodes can be utilized to update a knowledge base without having to completely regenerate the knowledge base.

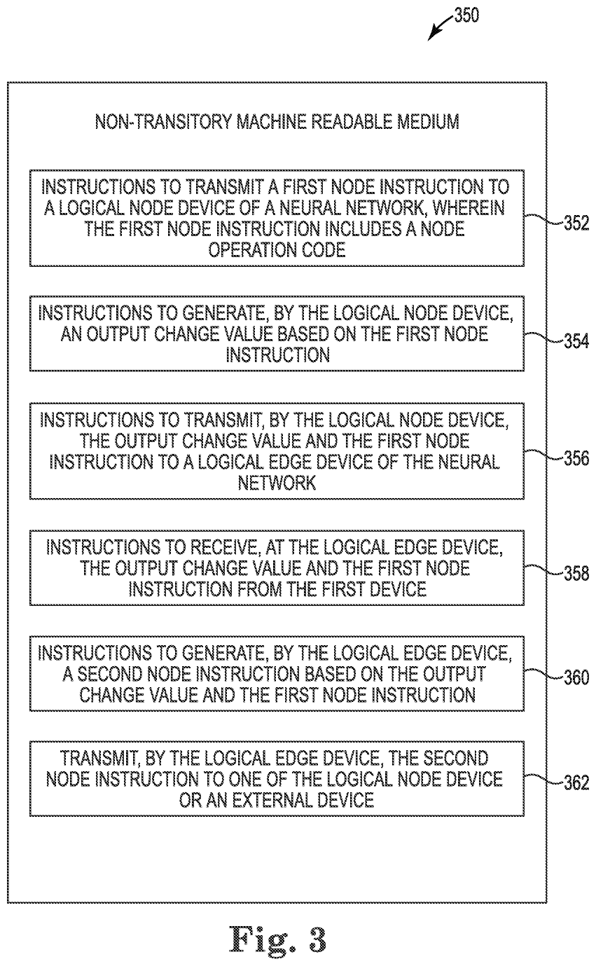

FIG. 3 illustrates a machine readable medium 350 storing instructions for transmitting node instructions consistent with the disclosure. In some examples, the machine readable medium 350 can be utilized to store instructions 352, 354, 356, 358, 360, 362 that can be executed by a processing resource. For example, the machine readable medium 350 may be communicatively coupled to a processing resource, which may be a central processing unit (CPU), a semiconductor-based microprocessor, and/or other hardware devices suitable for retrieval and execution of instructions 352, 354, 356, 358, 360, 362 stored in the machine readable medium 350 (e.g., in a non-transitory computer readable medium). The example processing resource may fetch, decode, and execute instructions. As an alternative, or in addition to, retrieving and executing instructions, the example processor may include an electronic circuit that may include electronic components for performing the functionality of executed instructions.

In some examples, the processing resource may be a plurality of hardware processing units that may cause machine-readable instructions to be executed. The processing resource may include central processing units (CPUs) among other types of processing units. The machine readable medium 350 may be a type of volatile or non-volatile memory or storage, such as random-access memory (RAM), flash memory, storage volumes, a hard disk, or a combination thereof.

The machine readable medium 350 may store instructions thereon, such as instructions 352, 354, 356, 358, 360, 362. When executed by the processing resource, the instructions may cause a device to perform specific tasks and/or functions. For example, the machine readable medium 350 may store instructions 352 which may be executed by the processing resource to cause the device to transmit a first node instruction to a logical node device of a neural network, wherein the first node instruction includes a node operation code.

As illustrated in FIG. 3, the machine readable medium 350 may store instructions 354 which may be executed by a processing resource to generate, by the logical node device, an output change value based on the first node instruction. For example, the instructions 354 can utilize a function that can be performed on values associated with the first node instruction. For example, the first node instruction can include a node operation code, an input change value, and/or a node index for a plurality of nodes within a neural network. In some examples, the function can utilize the node operation code and input change value to generate an output change value. In these examples, the output change value can be utilized to determine a plurality of nodes for transmitting the output change value and/or node instructions.

As illustrated in FIG. 3, the machine readable medium 350 may store instructions 356 which may be executed by a processing resource to transmit, by the logical node device, the output change value and the first node instruction to a logical edge device of the neural network. As described herein, the logical edge device of the neural network can be a logical partition of memory resources and/or processing resources that is communicatively coupled to logical nodes or external devices from the neural network. In this way, the logical edge device can communicate with a plurality of logical nodes, external devices, and/or systems. In some examples, the output change value and the first node instruction can be provided to the logical edge device of the neural network when the logical edge device or external device communicatively coupled to the logical edge device is affected by the output change value and/or the first node instruction. That is, values associated with the edge device are affected by the output change value and/or the first node instruction includes instructions to be performed by the edge device.

As illustrated in FIG. 3, the machine readable medium 350 may store instructions 358 which may be executed by a processing resource to receive, at the logical edge device, the output change value and the first node instruction from the logical node device. For example, the logical node device can be a first logical partition of a memory resource and the logical edge device can be a second logical partition of the memory resource. In some examples, the logical node device can be communicatively coupled to the logical edge device. In these examples, the output change value can be transmitted from the logical node device to the logical edge device through a communication path. In some examples, the output change value can be received at the logical edge device when the output change value affects or alters a state value of a logical node or external device that is coupled to the logical edge device.

As illustrated in FIG. 3, the machine readable medium 350 may store instructions 360 which may be executed by a processing resource to generate, by the logical edge device, a second node instruction based on the output change value and the first node instruction. For example, the logical edge device can utilize the output change value and the first node instruction as inputs for a function that can be utilized to determine a plurality of other logical nodes and/or devices that are affected by the output change value.

As illustrated in FIG. 3, the machine readable medium 350 may store instructions 362 which may be executed by a processing resource to transmit, by the logical edge device, the second node instruction to one of the logical node device and an external device. For example, the logical edge device can determine a plurality of logical nodes or devices for transmitting the second node instruction. In some examples, internal and/or external devices can be selected based on the output change value that is generated by the logical node device. In this way, internal or external devices that are not affected by the output change value are not updated or altered and internal or external devices that are affected by the output change value are updated based on the output change value and/or the second node instruction.

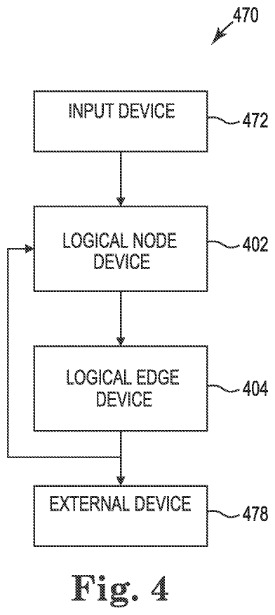

FIG. 4 illustrates a system 470 for transmitting node instructions consistent with the disclosure. As described herein, the system 470 may include a logical node device 402 and a logical edge device 404 to transmit node instructions. The logical node device 402 can be, for example, logical node 102 and/or logical node 202 previously described in connection with FIGS. 1 and 2. The logical edge device 404 can be, for example, logical node 104 and/or logical node 204 previously described in connection with FIGS. 1 and 2.

As described herein (e.g., in connection with FIG. 1), the logical node device 402 may be included within a neural network. As illustrated in FIG. 4, the logical node device 402 can receive a node instruction from an input device 472, where the input device 472 is located outside of the neural network. The node instruction can include, but are not limited to, a node operation code, a node input change value, and/or a node index. In some examples, the input device 472 can include a device to input conditions that can affect an output of a knowledge base. As described herein, a knowledge base can include a database with information relating to a plurality of devices. For example, the knowledge base can include a plurality of devices that include a plurality of different configurations and prices based on selected features (e.g., processor type, memory type, etc.).

In some examples, the input device 472 can be utilized to enter the particular conditions and/or selected features from the knowledge base. In some examples, the entered particular conditions can be converted into a change value that can be provided to the logical node device 402. In some examples, the input device 472 can generate the node instructions and input change value to determine a number of logical node devices such as logical node device 402 for transmitting the node instructions and input change value. For example, the input device 472 can determine that a portion of a plurality of logical node devices are not affected by the node instruction and/or input change value. In this example, the input device 472 may not provide the node instruction or input change value to the portion of the plurality of logical nodes that are not affected. As used herein, a logical node or device is affected by a change value when the change value alters the internal state of the logical node or device. In a similar way, a logical node or device is not affected by a change value when the change value does not alter the internal state of the logical node or device.

In a similar way, the input device 472 can determine that the logical node device 402 is affected by the node instruction and/or input change value. For example, the logical node device 402 can be affected by the node instruction when the logical node device 402 alters an internal state when the input change value is input into a function performed by the node device 402. For example, the logical node device 402 can be affected by the input change value when a node internal state of the logical node device 402 is to change in response to the input change value. In some examples, the logical node device 402 can update a corresponding portion of an output of the knowledge base based on the input change value and/or the node instruction provided by the input device 472. In this way the corresponding portion of the output of the knowledge base is updated to reflect a change in a condition that is input into the input device 472.

As illustrated in FIG. 4, the logical node device 402 can generate an output value based on the received first node instruction. As described herein, the output value can be generated based on an input value from the input device 472 and the first node instruction. In some examples, the output value can be an output change value that can be utilized to determine a number of logical nodes to provide the output change value based on whether the output change value affects the number of logical nodes.

As illustrated in FIG. 4, the logical node device 402 can include a node index (e.g., node memory map, neural network map, etc.) to instruct the logical node device 402 to transmit the node instruction to the logical edge device 404 when logical nodes or devices coupled to the edge device 404 are affected by the node instruction and/or an output change value generated by the logical node device 402. In some examples, the logical node device 402 can transmit the output change value and the node instruction to a logical edge device 404.

In some examples, the logical edge device 404 can receive the output change value and the node instruction from the logical node device 402 and generate a sequence of node instructions based on the output change value and the node instruction. In some examples, a sequence of node instructions can include a plurality of instructions for a plurality of corresponding logical nodes (e.g., logical node device 402, etc.). In some examples, the sequence of node instructions can be an ordered sequence of instructions to be performed by the plurality of corresponding logical nodes and/or external devices (e.g., external device 478, etc.). For example, the sequence of node instructions can transmit the output change value to a first portion of a plurality of logical nodes that utilize a first operation code (e.g., addition, etc.) and transmit the output change value to a second portion of the plurality of logical nodes that utilize a second operation code (e.g., subtraction, etc.). In this example, the first operation code and the second operation code can be different operation codes. In addition, the sequence of node instructions can identify a sequence to transmit the output change value for logical devices that utilize the first operation code prior to transmitting the output change value for logical devices that utilize the second operation code.

In some examples, the logical edge device 404 can transmit the sequence of node instructions and/or output change value to a logical node device 402 when the logical node device 402 is affected by the sequence of node instructions and/or the output change value. In some examples, cycles between the logical node device 402 and the logical edge device 404 can continue until the logical node device 402 is not affected by an output change value generated by the logical node device 402.

In some examples, the logical edge device 404 can transmit the sequence of node instructions to an external device 478 based on a node index of the sequence of node instructions being associated with the external device 478. In some examples, the node instructions or sequence of node instructions can be utilized to determine that the external device 478 is affected by the output change value and/or the node instructions. For example, the external device 478 may perform an update or generate a portion of an output associated with a knowledge base based on the output change value.

In these examples, the external device 478 can receive node instructions and/or an output change value from the logical edge device 404 and execute instructions based on the received node instructions and/or output change value. In some examples, the external device 478 can be an application or service for generating the knowledge base as described herein. In this way, the portions of the knowledge base that are affected by condition inputs provided to the input device 472 can be altered or updated and portions of the knowledge base that are not affected by condition inputs can remain the same as a previous version of the knowledge base with different condition inputs.

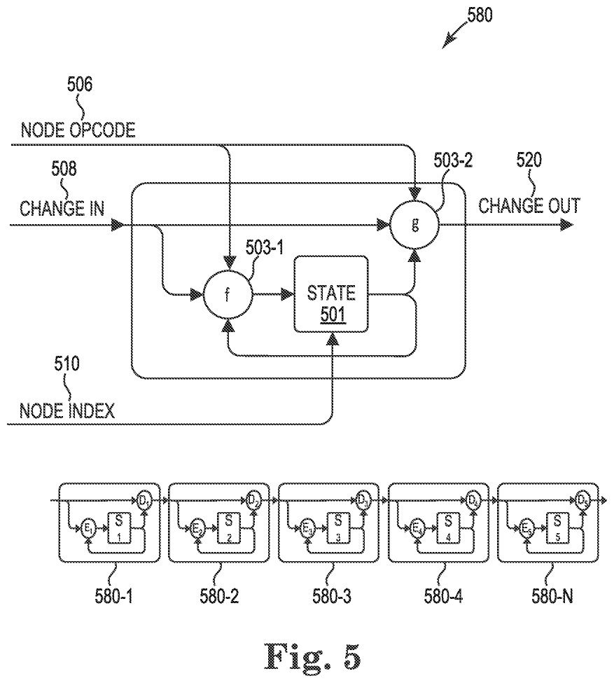

FIG. 5 illustrates nodes 580 for transmitting node instructions consistent with the disclosure. In some examples, the nodes 580 can illustrate a logical node device and/or a logical edge device as described herein. In some examples, the nodes 580 can be aligned such that an input change value from a second node 580-2 can be received by a first node 580-1 and utilized by the second node 580-2 to generate an output change value. In this example, the output change value can be transmitted to a third node 580-3 and utilized to generate an updated output change value.

In some examples, the node 580 can illustrate that a node operation code 506 and/or an input change value 508 can be provided to a first function 503-1. In some examples, the first function 503-1 can generate an internal state 501 based on the node operation code 506 and/or the input change value 508. In some examples, the state 501 can receive a node index 510 to determine a relationship of the input change value 508 and how the input change value 508 may affect other nodes within a neural network. In some examples, the determined internal state 501, node operation code 506, and/or the input change value 508 can be provided to a second function 503-2 that can be utilized to calculate an output change value 520. In some examples, the output change value 520 can be transmitted to a different node within the neural network based on how the output change value 520 affects other nodes within the neural network. For example, the output change value 520 can be transmitted to a first logical node that is affected by the output change value 520 and not transmitted to a second logical node that is not affected by the output change value 520.

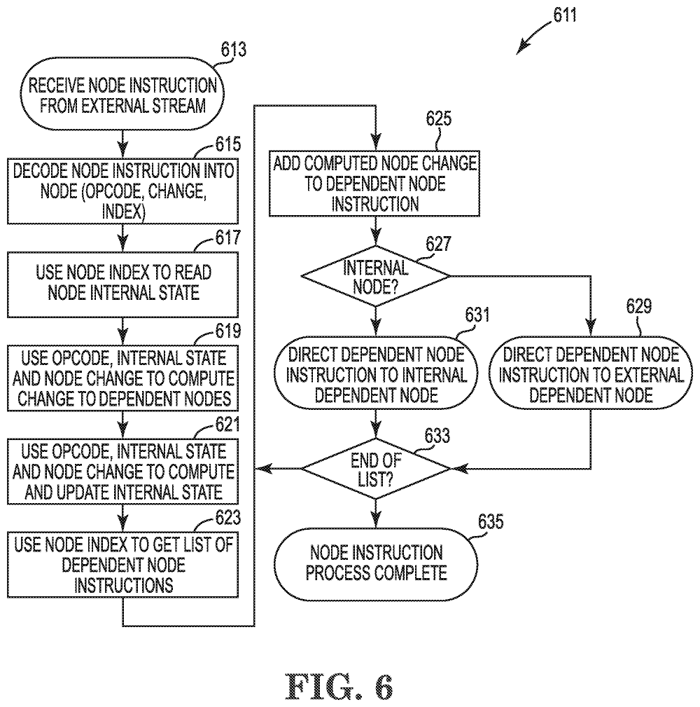

FIG. 6 illustrates a flow diagram 611 for transmitting node instructions consistent with the disclosure. In some examples the flow diagram 611 can illustrate a method flow that can be performed or executed by a computing device. For example, the flow diagram 611 can illustrate instructions that can be executed by a processing resource. In some examples, the flow diagram 611 can start by receiving node instruction from an external stream at 613. As used herein, an external stream can include a device, system, or stream of devices that are capable of communicating with a neural network.

In some examples, the flow diagram 611 can include decoding node instructions into node instructions (e.g., opcode, change, index, etc.). As described herein, the information received from an external source or input device (e.g., input device 472 as illustrated in FIG. 4, etc.) can include an input that changes outputs provided by a knowledge base that has been converted to a neural network. In some examples, the input can be converted into a change value based on how the input affects the knowledge base and/or outputs generated by the knowledge base. For example, a first input can alter a first node state of a first node without affecting a second node state of a second node. In a similar way a second input can alter a second node state of a second node without affecting a first node state of a first node.

In some examples, the flow diagram 611 can include using a node index to read a node internal state at 617. As described herein, a node index can illustrate a plurality of logical nodes of a neural network and corresponding state values for the plurality of logical nodes. In this way, it can be determined how a change value can affect each of the plurality of logical nodes based on the current state value of the node and an operation code associated with the node. In some examples, the state value (e.g., internal state value, etc.) can include a plurality of values. For example, a node that utilizes an operation code that corresponds to an “if-then-else” function can include three internal values that corresponds to each “if” value, “then” value, and “else” value. In this example, a change to any of the values can change the internal state of the logical node and/or an output change value for the logical node.

In some examples, the state value can be a shared state value compared to a local state value. For example, a local state value can be a state value that is stored locally on the logical node whereas a shared state value can be stored in a non-local location and shared among a plurality of logical nodes. In these examples, a change value that affects the shared state value can affect all of the logical nodes that share the shared state value. In some examples, a logical node can include a local state value and a shared state value based on the operation code of the logical node and/or relationships between the logical node and other logical nodes. Similarly the node output change value can be multiple values that conditionally impact different dependent nodes in different ways. For example, a logical node can produce a plurality of interdependent values that can be directed to different dependent nodes. For example, a first value can be provided to a first set of dependent nodes and a second value that is different than the first value can be provided to a second set of dependent nodes.

In some examples, the flow diagram 611 can include using an operation code, internal state, and node change (e.g., change value, input change value, etc.) to compute change to dependent nodes at 619. As described herein, the operation code, internal state of a node, and/or the change value can be utilized to determine nodes (e.g., dependent nodes, etc.) that are affected by the change value. As used herein, the dependent nodes can be nodes that are child nodes or downstream nodes of a particular parent node or upstream node.

In some examples, the flow diagram 611 can include using the operation code, internal state, and node change to compute and update an internal state for the node at 621. As described herein, the change value can alter an internal state value for a particular logical node. In this way, the logical node is able to update the internal change value based on an input and update a corresponding element or feature of an output of a knowledge base based on an input.

In some examples, the flow diagram 611 can include using a node index to get a list of dependent node instructions at 623. As described herein, the dependent node instruction can be a second node instruction generated by a logical edge or logical edge device. In some examples, the list of dependent node instructions can illustrate instructions to be provide to the list of dependent nodes when the dependent nodes are provided with the output change value. In these examples, the computed node change can be added to the dependent node instruction at 625. In some examples, generating a list of dependent nodes can include providing the index of a first node and a count value. For example, a starting node can have an index value of 100 and a count value of 50. In this example, a list of 50 numerically consecutive node indexed instructions can be generated. In this example, the node instruction operation code can be used to determine the encoding format to be used to decode the individual node instructions from the logical edge.

In some examples, the flow diagram 611 can determine if a dependent node is an internal node of the neural network at 627. If the dependent node is an internal node, the flow diagram 611 moves to direct dependent node instruction to internal dependent node at 631. If the dependent node is not an internal node, the flow diagram 611 can direct dependent node instruction to external dependent node at 629. When the node instruction has been provided to either the internal dependent node or the external dependent node, the flow diagram 611 can determine if it is the end of the list of dependent nodes at 633. If it is determined that it is not at the end of the list of dependent nodes, the flow diagram 611 can add computed node change to dependent node instruction at 625 and repeat step 627. If it is determined that it is the end of the list of dependent nodes, the flow diagram 611 can determine that the process is complete at 635.

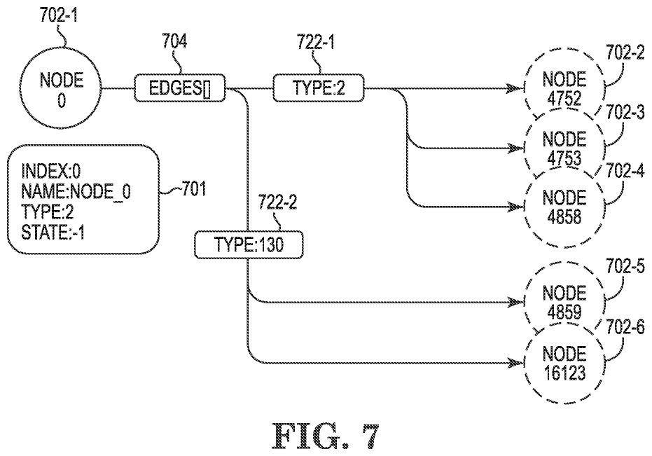

FIG. 7 illustrates a logical edge 704 for transmitting node instructions consistent with the disclosure. FIG. 7 illustrates the logical edge 704 being communicatively coupled between a logical node 702-1 and a plurality of additional logical nodes 702-2, 702-3, 702-4, 702-5, 702-6. As described herein, the logical node 702-1 can receive a change value and update node internal state 701 based on a node index, current node internal state, the change value, and/or the operation code of the logical node 702-1.

As described herein, the logical node 702-1 can provide the updated change value or resulting change value to the logical edge 704. In these examples, the logical edge 702 can determine an operation code 722-1 for a first plurality of nodes 702-2, 702-3, 702-4 and an operation code 722-2 for a second plurality of nodes 702-5, 702-6. As described herein, an operation code can be a function to be performed when receiving a change value from the logical edge 704. For example, the operation code 722-1 can be a add operation code that instructs the logical nodes 702-2, 702-3, 702-4 to add the change value to their respective current internal state value. In this example, the operation code 722-2 can be a subtract operation code that instructs the logical nodes 702-5, 702-6 to subtract the change value from their respective current internal state value. Thus, a particular change value may affect the logical nodes 702-2, 702-3, 702-4 based on the operation code 722-1 and the same particular change value may not affect the logical nodes 702-5, 702-6 based on the operation code 722-2.

In some examples, the logical edge 704 can utilize the operation codes 722-1, 722-2, change value received from the logical node 702-1, and an internal state value of the plurality of logical nodes 702-2, 702-3, 702-4, 702-5, 702-6 to determine which of the plurality of logical nodes 702-2, 702-3, 702-4, 702-5, 702-6 are affected by the change value and which of the plurality of logical nodes 702-2, 702-3, 702-4, 702-5, 702-6 are not affected by the change value. In this way, only the plurality of logical nodes 702-2, 702-3, 702-4, 702-5, 702-6 that are affected by the change value are updated or altered as described herein.

In some examples, the logical edge 704 can provide the change value from the logical node 702-1 to each of a plurality of nodes between the logical edge 704 and logical node 702-2 before providing the change value to a plurality of nodes between the logical edge 704 and the logical node 702-3. The plurality of nodes between the logical edge 704 and the logical nodes 702-2, 702-3, 702-4, 702-5, 702-6 for illustrative purposes. In some examples, the logical edge 704 can provide the change value from the logical node 702-1 to each of a plurality of nodes 702-2, 702-3, 702-4 associated with the operation code 722-1 before providing the change value to each of the plurality of nodes 702-5, 702-6 associated with the operation code 722-2.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications and use of the system and method of the disclosure. Since many examples can be made without departing from the spirit and scope of the system and method of the disclosure, this specification merely sets forth some of the many possible example configurations and implementations.

What is claimed:

1. A device, comprising:
a logical node of a neural network to:
receive a first node instruction;
generate an output change value based on the received first node instruction; and
transmit the output change value and the first node instruction to a logical edge; and
the logical edge of the neural network to:
receive the output change value and the first node instruction from the logical node;
generate a second node instruction based on the output change value and the first node instruction; and
transmit the second node instruction.

2. The device of claim 1, wherein the logical node is a logical node device and the logical edge is a logical edge device.

3. The device of claim 1, wherein the logical node is to determine the logical edge is affected by the output change value.

4. The device of claim 1, wherein the first node instruction and the second node instruction include a node operation code, a node input change value, and a node index.

5. The device of claim 1, wherein the logical edge is to transmit the second node instruction to the logical node in response to a node index of the second node instruction being associated with the logical node.

6. The device of claim 1, wherein the logical edge transmits the second node instruction to an external device based on a node index of the second node instruction being associated with the external device.

7. The device of claim 1, wherein the logical node receives the first node instruction from an external device.

8. A non-transitory machine readable medium storing instructions executable by a processing resource to:
transmit a first node instruction to a logical node device of a neural network, wherein the first node instruction includes a node operation code;
generate, by the logical node device, an output change value based on the first node instruction;
transmit, by the logical node device, the output change value and the first node instruction to a logical edge device of the neural network;
receive, at the logical edge device, the output change value and the first node instruction from the first device;
generate, by the logical edge device, a second node instruction based on the output change value and the first node instruction; and
transmit, by the logical edge device, the second node instruction to one of the logical node device or an external device.

9. The medium of claim 8, wherein the first node instruction includes a node index, wherein the second node instruction is based on the node index and the output change value.

10. The medium of claim 8, wherein second node instruction is transmitted to one of the logical node device and an external device based on the node operation code.

11. The medium of claim 8, wherein the neural network generates a set of node instructions simultaneously.

12. A system, comprising:
a logical node device of a neural network to:
receive a node instruction, wherein the node instruction includes a node operation code, a node input change value, and a node index;
generate an output change value based on the received node instruction; and
transmit the output change value and the node instruction to a logical edge device; and
the logical edge device of the neural network to:
receive the output change value and the node instruction from the logical node device;
generate a sequence of node instructions based on the output change value and the node instruction;
transmit the sequence of node instructions to the first logical node device in response to a node index of the sequence of node instructions being associated with the first logical node device; and
transmit the sequence of node instructions to an external device based on a node index of the sequence of node instructions being associated with the external device.

13. The system of claim 12, wherein the logical node device includes a node memory map to instruct the logical node device to transmit the node instruction to the logical edge device.

14. The system of claim 12, wherein the logical edge device includes a node edge map to instruct the logical edge device to transmit the sequence of node instructions to the external device.

15. The system of claim 12, wherein the logical edge device encodes a set of partial node instructions including the node operation code and the node index.
